(19) United States
(12) Patent Application Publication
(10) Pub. No.: US 2024/0152981 A1
(43) Pub. Date: May 9, 2024

(54) METHOD OF SELECTING A FRACTIONAL PORTION OF A BULK ORDER

(71) Applicant: Rebuy Inc, Edina, MN (US)

(72) Inventor: John Robert Erck, Edina, MN (US)

(73) Assignee: Rebuy Inc., Edina, MN (US)

(21) Appl. No.: 17/980,132

(22) Filed: Nov. 3, 2022

(51) Int. Cl. G06Q 30/06

(52) U.S. Cl. CPC G06Q 30/0605; G06Q 10/0875

(57) ABSTRACT

A method of selecting a fractional portion of a bulk order includes a user selecting a quantity of in-stock goods to be purchased to define a stored product. A portion of the stored product is received by the user when the user is presented fractioning options by a software application. The fractioning options include a step of the user determining a parceled quantity of the stored product to be parceled out for remote delivery and a second step of choosing an arbitrary date for shipment of the parceled quantity to allow the user the ability to determine when and how much of the stored product will be received by the user. These steps continue until the amount of the stored product is reduced to zero.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to system for buying bulk goods and more particularly pertains to a new system for buying bulk goods wherein a user may purchase goods by bulk ordering without a requirement that the user receives the total amount purchased in one shipment. In particular, the disclosure teaches a method wherein a user selects a quantity of in-stock goods to be purchased to define a stored product. A portion of the stored product is received by the user when the user is presented fractioning options by a software application. The fractioning options include a step of the user determining a parceled quantity of the stored product to be parceled out for remote delivery and a second step of choosing an arbitrary date for shipment of the parceled quantity to allow the user the ability to determine when and how much of the stored product will be received by the user. These steps continue until the amount of the stored product is reduced to zero. The user may, of course, add to the stored product before or when the amount of stored product is depleted to zero.

The above, generally, allows a consumer to buy a quantity of goods in a bulk order to minimize cost, as many goods sold in bulk are offered at reduced price, and to hedge against future increases in the costs of those goods. Moreover, by allowing the consumer to determine the size and shipment timing of each fractional portion of the stored product, the consumer will not be burdened with receiving a shipment before the last received shipment of goods were consumed. Thus, the consumer need not be concerned about storage of overstocked goods or spoilage of perishable goods. Equally, a merchant utilizing the system will be able to make large sales and be better prepared for future on-demand requests and deliveries. The merchant can also build the cost of storage into their fees passed along to the consumer. The merchant will, over time, also detect patterns of consumers to better streamline the process of moving goods from an initial supplier and to the end consumer or retailer.

### (2) Description of Related Art Including Information Disclosed Under 37 CFR 1.97 and 1.98

The prior art relates to systems for buying bulk goods which are typically subscription based. The process of utilizing such subscriptions typically requires a purchaser to determine a length of time that they will be beholden to the merchant for periodic deliveries of goods which are typically based upon equal segments of time. Thus, in one example, a purchaser will agree to a subscription for a lower per good fee but will receive a pre-determined amount of those goods each month on the first of the month. Regardless of whether the purchaser has consumed the goods from the prior month, the next month's delivery of goods will still come to the purchaser. The purchaser, therefore, is placed in a position of having to store un-used goods and does not provide the merchant with information regarding trends.

The above therefore demonstrates two problem which have gone unsolved for the consumer ordering in bulk. The first is that the consumer has not been able to dictate when they receive a pre-proportioned shipment. That is, the consumer, upon purchasing goods in bulk, has been forced to choose between one option where the entire amount of the bulk ordered goods were shipped in one shipment or another option where the bulk ordered goods were split into multiple, equally sized portions and those portions were shipped at equal time intervals. Both options inevitably lead to unused product due to spoilage, aging out, or simply being discarded for lack of storage space. The second problem is that the current systems to not allow a user to alter the amount of product removed from the bulk order to be shipped. The system explained herein allows the consumer to alter the quantity of product in each subsequent shipment based upon changing needs or understanding that prior shipments should have been larger or smaller.

### (h) BRIEF SUMMARY OF THE INVENTION

An embodiment of the disclosure meets the needs presented above by generally comprising a user selecting a quantity of in-stock goods to be purchased to define a stored product. A portion of the stored product is received by the user when the user is presented fractioning options by a software application. The fractioning options allow the user to selectively determine a parceled quantity of the stored product to be parceled out for remote delivery to the user to define a deliverable product. The stored product thereafter is generally defined as being equal to x-y, wherein x equals a total remaining quantity of the stored product and y equals the parceled quantity removed from the stored product as the deliverable product. The user, after determined the parceled quantity, next uses the software application to select a date for shipping and/or receiving of the deliverable product. The date selected is arbitrary in that the user is not required to select equal segments of time. The steps of determining the parceled quantity amount and its ship date is repeated until x-y equals 0.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a schematic flow chart view of a method of selecting a fractional portion of a bulk order according to an embodiment of the disclosure.

FIG. 2 is a schematic view of an embodiment of the disclosure.

### (j) DETAILED DESCRIPTION OF THE INVENTION

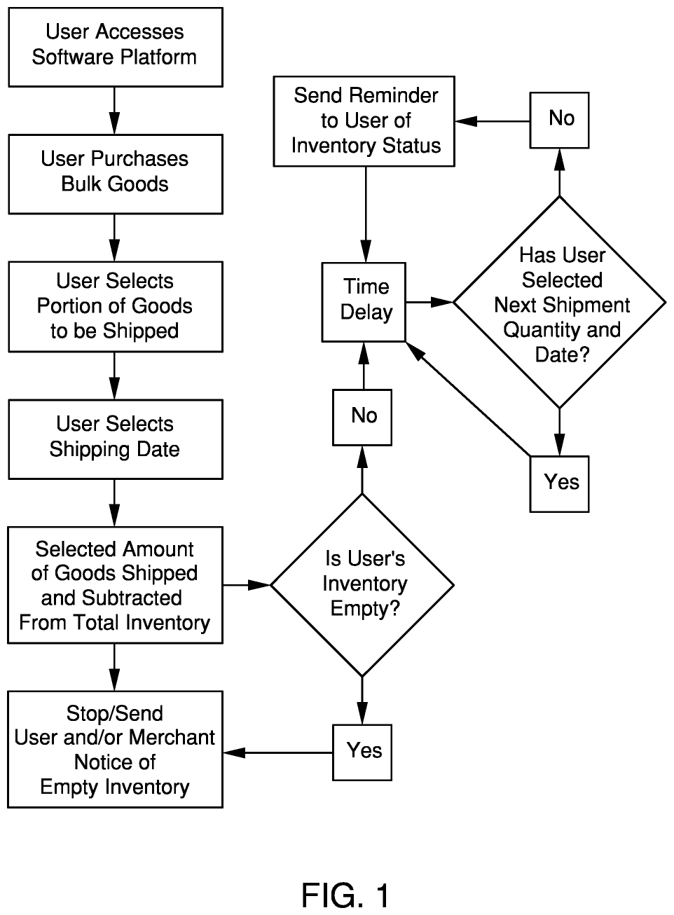

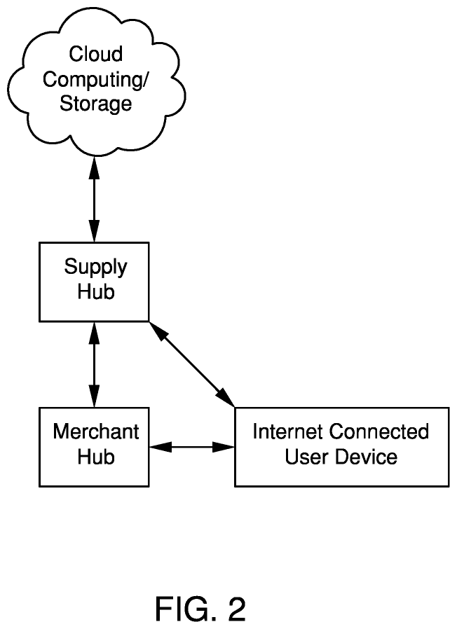

With reference now to the drawings, and in particular to FIGS. 1 and 2 thereof, a new system for buying bulk goods embodying the principles and concepts of an embodiment of the disclosure and generally designated by the reference numeral 10 will be described.

As best illustrated in FIGS. 1 and 2, the method 10 of selecting a fractional portion of a bulk order generally comprises a system and method 10 allowing a user or purchaser to purchase a large, i.e. bulk, quantity of a commodity and thereafter controlling how the quantity is to be divided into portions as well as when that portion divided out of the quantity will be shipped to the entity. Moreover, once a user selects a portion to be shipped, they may later alter the size of the portion as well. To facilitate this system and method, there will typically be provided a merchant hub in communication with a supply hub.

The merchant hub is the “front end” of the system which is viewed by consumers which are, generically, the purchasers wanting to purchase bulk goods. The term “bulk goods” herein is generally defined as a quantity of a specific good which is larger than would be needed in a single, isolated sales purchase. Thus, a consumer may want to purchase paper towel rolls in bulk but only require twelve paper towel rolls on average per month and therefore might purchase that number per month in an isolated purchase. This is different than a bulk order wherein, for example, the consumer purchases paper towel rolls in bulk and thus buys one hundred twenty paper towel rolls in one purchase transaction and thereafter must store a relatively large amount of goods purchased for later consumption. The merchant hub, to facilitate purchases, therefore includes a computer data system providing an interface to interact with the purchasers. The interface will include conventional computers, memory storage systems, programs, and internet communication capabilities. The merchant hub may be located in one physical location or in multiple locations including utilization of cloud computing.

The supply hub includes data related to bulk goods that are tentatively available for purchase and may include in-stock goods or out of stock goods. The term “in-stock” as used herein may define goods that a merchant currently has custody of or may include items that the merchant will have in the future Therefore, the term is generally used only as a notification to a prospective buyer that the goods can be purchased in bulk. The supply hub will typically be in communication with multiple subsidiary hubs to provide information on the availability of goods to be purchased. The subsidiary hubs may include goods defining specialized products. For example, while one subsidiary hub may have access to paper goods, another may have access to citrus fruits. There may also be redundancies in subsidiary hubs to verify lower prices as well as increase the number of sources for each of the goods. The supply hub may be incorporated into the merchant hub wherein the merchant hub is in remote and direct communication with the subsidiary hubs in. A user of the method 10 might not typically see or be knowledgeable of the supply hub or the subsidiary hubs and will only interact with the merchant hub. Thus, the merchant hub acts as a “storefront” for the user. As shown in FIG. 2, there are multiple ways for a user to interact with such a system.

In practice, the supply hub may be directing most interactions with the user through the merchant hub, while the merchant hub provides the appearance and input of the interactions as well offering customizable options. However, in some instances the supply hub may also act as a merchant hub in which case the user's interactions would be direct with the supply hub without an intervening storefront. Alternatively, the merchant hub could be utilized for initiating a first sale of a good and thereafter the user may be working only with the supply hub. It should be understood that the above are only generic examples of a system that may be organized in numerous ways to satisfy the method 10 discussed herein.

To utilize the method 10, a user will download a software application onto a personal computing device that is in remote communication with the merchant hub. The communication between the personal computing device and the merchant hub is most often through the internet. Typically, the personal computing device will comprise a cellular phone having internet access to the merchant hub via a cellular or Wi-Fi connection. Alternatively, the personal computing device may comprise a desktop computer, a laptop computer, a computer tablet, or the like. The software application may alternatively be accessed through a webpage viewed on the personal computing device, wherein the webpage may be provided by the merchant hub or a third party.

The software application allows engagement of interactions between the merchant hub and the personal computing device. These interactions most typically includes accessing, and displaying for purchase, those bulk goods that are identified as the in-stock goods. The software application may also list those goods which are out of stock goods as well as allowing a user to select a request to be notified when a particular good, which is out of stock, is again in-stock. Additional interactions provided for by the software application include selecting for purchase of desired ones of the in-stock goods and authorizing the transferring of funds for the purchase of in-stock goods. It should be understood that the transferring of funds may further include third parties authorized by the user to transfer funds when directed to do so. Additional interactions may include requests by a user for forced reception of notifications from the merchant hub for price discounts, specials offers, and the like.

While using the method 10, the user software application will display in-stock goods on the personal computing device. Generally, the software application will also allow the user to enter queries to search for specific types of goods to be listed. Using standard algorithms the software application will search the supply hub for those goods matching the query term(s) and list those goods which are in-stock and available for purchase. In addition to presenting the goods available for purchase, the software application may also provide pricing terms for which the goods are available and allowing the user to select a quantity that may alter the price of the goods based upon the quantity of the goods ordered and the timeframe in which the totality of the goods will be delivered. While the method 10 generally allows a consumer to determine shipment dates independently of each other, the price terms may vary depending on the duration of time required by the consumer to fully deliver the purchased goods. Thus, the price may vary not only based upon the quantity of goods purchased, but timeframe in which those goods divided apart and delivered.

Once the user determines which in-stock goods are desired, the user actuates the personal computing device to select the in-stock goods to be purchased and transfers funds for the in-stock goods being purchased. Upon confirmation of the funds being properly transferred, the in-stock goods for which funds were transferred define a stored product that are now owned by the user. It is noted that stored product may, or may not, actually exist in storage or, furthermore, may be located in numerous, disparate locations. Since the user is buying goods in bulk, the supply hub need not have immediately on hand the total amount of goods being purchased. Therefore, the merchant hub or supply hub, may further calculate whether the amount of goods on hand combined with presumed and known in-coming deliverables will satisfy the requirements of the user's purchase. Thus, the software application's interaction may require estimated dates of shipments from the user.

After or during the purchasing of the goods, the user will also be alerted by the software application to determine what portion of the stored product the user would like to receive in a first shipment. The user will also be prompted to enter a desired shipping and/or receiving date to receive that selected portion. More specifically, the user will be presented with fractioning options by the software application. The fractioning options allow the user to selectively determine a parceled quantity of the stored product to be parceled out for remote delivery to the user to define deliverable product. The stored product thereafter is defined as x-y, wherein x equals a total remaining quantity of the stored product and y equals the parceled quantity removed from the stored product as the deliverable product. This may be computed in either percentage of the stored quantity or by means conventional to calculating the amount of a particular good, i.e. weight or specific number of items. Thus, should the user request 5% of the stored product to be shipped, x=100% and y=5%. Thereafter, x will again represent 100% of the stored product. If the stored product is measured strictly as a particular unit, x will become the remaining amount of the stored product in those units. Consequently, if x represents 1000 lbs. of flour the user requests 150 lbs., x thereafter becomes 850 lbs. The fractioning or parceling out from the stored product will continue until x is equal to 0.

Once the user has determined the parceled quantity, the date of the shipment or reception of the parceled quantity is selected. The software application allows the user to selectively determine when the date will occur, and the date therefore is arbitrary with respect to the method 10 as the user, and not the merchant or software, determines the date of shipment. That is, while the software application can be programmed to allow for equal increments of time to pass to automatically ship out a parceled quantity, the purpose of the method 10 is to allow the user control of when those shipments are made without concern that a shipment will automatically be sent without action on the part of the user. Thus, the software application will be programmed to require the user to select the parceled quantity and verify the date of each shipping transaction individually. Another interaction between with user on the personal computing device may include the software application periodically notifying the user that their arbitrary shipment date has not yet been selected.

In one embodiment, the method 10 may include the ability of the customer to alter the good as they are being parceled out in shipments. Generally, this option would be available when the goods have equal cost and are generically the same good, but which are offered with variations. Thus, a user may wish to buy ice-cream in bulk but during the process of requesting a parceled quantity, they may switch the flavors of the ice-cream to be shipped.

In use, therefore, the method 10 allows a user to purchase goods in a bulk fashion and thereafter determine when and how much of the stored product will be sent to the user or the user's selected shipment receiving location. This affords the user the ability to lower and control costs for purchasing goods without the concern of having to store vast quantities of product or risking spoilage of un-used product. The software application may be programmed to provide a time/date limit by which the entire purchase must be shipped to prevent unreasonable storage requirement and production costs of the goods. These limits may be designed on a case by case basis depending on the goods being transferred and provided by the supply hub for dissemination to the user through the software application. The software application may further be programmed to send alert reminders to the user that goods still exist from their original order to ensure that the user does not forget any goods remaining in storage.

FIG. 1 provides one example of a method wherein the user accesses the supply hub via the software platform to purchase goods in bulk fashion. The user then selects a portion, i.e. parceled quantity, of the purchased bulk goods to be shipped on a selected date. The amount selected is subtracted from the inventory of bulk goods and shipped to the user to define deliverable product. If the shipment completely depletes the inventory, i.e. stored product, the software application may be programmed to alert the user, the merchant controlling the merchant hub, or both that the user has no remaining inventory of the bulk goods and that re-ordering of the goods is required for future shipments. If the inventory is not fully depleted, the software application may include a time delay to alert the user that it may be time to retrieve goods from the inventory. The time delay may be a fixed, pre-selected amount of time. However, in some instances the software application may be programmed to learn an average rate of consumption for each good and thereafter use this rate of consumption to create the time used for the time delay. As the time delay is eclipsed, the software application will send the reminder to the user. Should the user not access the software platform to re-initiate a shipment, the software application may start another time delay of the same or different length to again remind the user at a later date that inventory still remains.

With respect to the above description then, it is to be realized that the optimum relationships of the systems of an embodiment enabled by the disclosure, to include variations in function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method for selectively fracturing a purchased bulk order into discrete units, said method including the steps of:
selecting by a user a quantity of in-stock goods to be purchased to define a stored product;
receiving a portion of the stored product by the user by:
(a) presenting fractioning options to the user by a software application, the fractioning options allowing the user to selectively determine a parceled quantity of the stored product to be parceled out for remote delivery to the user and defining deliverable product, the stored product thereafter being defined as:
x-y, wherein x equals a total remaining quantity of the stored product and y equals the parceled quantity removed from the stored product as the deliverable product;
(b) selecting a date for shipping or for receiving the deliverable product wherein the date selected is arbitrarily chosen by the user; and
repeating steps (a) and (b) by the user of the software application until x-y equals 0.

2. A method for selectively fracturing a purchased bulk order into discrete units, said method including the steps of:
providing a merchant hub in communication with a supply hub, said supply hub including data related to bulk goods, said bulk goods being identified as in-stock goods or out of stock goods;
downloading a software application onto a personal computing device, the personal computing being in remote communication with the merchant hub;
using the software application to engage in interactions between the merchant hub and the personal computing device, the interactions including:
accessing bulk goods are identified as the in-stock goods;
selecting for purchase the in-stock goods;
transferring funds for the purchase of the in-stock goods;
displaying in-stock goods on the personal computing device;
selecting by a user the in-stock goods to be purchased and transferring funds for the in-stock goods to be purchased by actuating the personal computing device whereupon the in-stock goods for which funds were transferred define a stored product;
receiving a portion of the stored product by the user by:
(a) presenting fractioning options to the user by the software application, the fractioning options allowing the user to selectively determine a parceled quantity of the stored product to be parceled out for remote delivery to the user and defining deliverable product, the stored product thereafter being defined as:
x-y, wherein x equals a total remaining quantity of the stored product and y equals the parceled quantity removed from the stored product as the deliverable product;
(b) selecting a date for shipping or for receiving the deliverable product wherein the date selected may be an arbitrary date selected by the user or based on increments of time; and
repeating steps (a) and (b) by a user of the software application until x-y equals 0.

3. A method for selectively fracturing a purchased bulk order into discrete units, said method including the steps of:
providing a merchant hub in communication with a supply hub, said supply hub including data related to bulk goods, said bulk goods being identified as in-stock goods or out of stock goods;
accessing a software application on a personal computing device, the personal computing being in remote communication with the merchant hub;
using the software application to engage in interactions between the merchant hub and the personal computing device, the interactions including:
accessing bulk goods are identified as the in-stock goods;
selecting for purchase the in-stock goods;
transferring funds for the purchase of the in-stock goods;
selecting a request for notification from the merchant hub for desired goods listed as out of stock goods;
receiving a notification for desired goods listed as out of stock goods;
receiving notifications from the merchant hub for lowered pricing for previously purchased in-stock goods;
displaying in-stock goods on the personal computing device;
selecting by a user the in-stock goods to be purchased and transferring funds for the in-stock goods to be purchased by actuating the personal computing device whereupon the in-stock goods for which funds were transferred define a stored product;
receiving a portion of the stored product by the user by:
(a) presenting fractioning options to the user by the software application, the fractioning options allowing the user to selectively determine a parceled quantity of the stored product to be parceled out for remote delivery to the user and defining deliverable product, the stored product thereafter being defined as:
x-y, wherein x equals a total remaining quantity of the stored product and y equals the parceled quantity removed from the stored product as the deliverable product;
(b) selecting a date for shipping or for receiving the deliverable product wherein the date selected may be an arbitrary date selected by the user or based on increments of time;
repeating steps (a) and (b) by a user of the software application until x-y equals 0.
